(19) United States
(12) Patent Application Publication
(10) Pub. No.: US 2008/0059917 A1
(43) Pub. Date: Mar. 6, 2008

(54) Antenna Manufacturing Method and Communication Equipment Manufacturing Method

(76) Inventors: Hidehito Shimizu, Osaka (JP); Kazunari Hiraide, Osaka (JP); Yukinori Sasaki, Hyogo (JP); Mamoru Ito, Hyogo (JP)

Correspondence Address: WENDEROTH, LIND & PONACK L.L.P., 2033 K. STREET, NW, SUITE 800, WASHINGTON, DC, 20006, US

(21) Appl. No.: 11/630,899

(22) PCT Filed: Apr. 12, 2006
(86) PCT No.: PCT/JP06/07705

§ 371 Date: Dec. 27, 2006

(30) Foreign Application Priority Data
Apr. 12, 2005 (JP) 2005-114143

(51) Int. Cl. G06F 17/50

(52) U.S. Cl. 716/2

(57) ABSTRACT

An antenna manufacturing method including the step of inputting as variables shape of a case, position of an antenna in the case, shape of the antenna, position of antenna peripheral components in the case, and shape of the antenna peripheral components, and the step of computing optimum value of the variables by a simulation program. With this manufacturing method, radiation efficiency of the antenna and the communications device that uses it can be enhanced.

### TECHNICAL FIELD

The present invention relates to manufacturing method of antennas and manufacturing method of communications devices in which influence of case and antenna peripheral components is taken into consideration.

### BACKGROUND ART

Along with the recent trend toward miniaturization of information-related devices, various electronic components are also being miniaturized and designed to be low in profile. Antennas to be mounted on mobile phones are no exception and are demanded to be miniaturized. Generally speaking, however, as the size of an antenna becomes smaller, electromagnetic radiation efficiency decreases and becomes highly sensitive to peripheral components. Accordingly, an antenna design becomes necessary in which the effect of the case and peripheral components of the antenna is taken into consideration.

FIG. 7 is a flow chart of a conventional antenna manufacturing method. FIG. 8 is a structural diagram of a conventional antenna.

A description of the flow chart of FIG. 7 will be given in the following.

(1) In step S701, antenna pattern 11 as shown in FIG. 8 is designed based on a theoretical equation.

(2) In step S702, impedance of an entire antenna element including matching element 12 is obtained by computer simulation.

(3) In step S703, designed antenna pattern 11 and a land portion (not drawn) for matching element 12 are simultaneously formed through a printed circuit forming process.

(4) In step S704, matching element 12 is mounted.

(5) In step S705, the characteristic of matching element 12 is adjusted.

Antennae used to be manufactured by sequentially carrying out the above steps (1) to (5) while matching the impedance.

As a related art literature to this filing, Japanese Patent Unexamined Publication No. 2004-282250, for example, is known.

However, antennas manufactured by a conventional manufacturing method suffered a problem of having poor radiation efficiency. To be more specific, as matching element 12 is used for the purpose of impedance matching, a power loss proportional to the impedance of matching element 12 occurs. As a result, the power transmitted to antenna pattern 11 decreases thus resulting in a decrease in the radiation efficiency.

There is also a conventional art in which antenna peripheral components and an antenna are separately designed and the antenna configuration is subsequently finely adjusted while measuring antenna characteristic. However, as the configuration of the antenna is changed while the configuration of the antenna peripheral components is fixed, dynamic alteration is not feasible. Consequently, it was not possible to obtain optimum configuration and optimum impedance matching.

### SUMMARY OF THE INVENTION

The present invention concerns a method of manufacturing an antenna comprising a step of inputting, as variables, the configuration of a case, position of an antenna in the case, the configuration of the antenna, positions of antenna peripheral components in the case, and the configurations of the antenna peripheral components; and a step of computing optimum values of the variables based on a simulation program.

In the antenna manufacturing method in accordance with the present invention, as simulation is performed using as the variables not only information on the antenna but also information on the peripheral components, optimization including impedance matching of an entire communications device including the antenna can be made. Accordingly, radiation efficiency of the antenna can be improved without calling for a matching element.

Also, as the antenna peripheral components and the antenna are simultaneously designed in the present invention, an ad hoc design can be made of the antenna configuration and the antenna peripheral components. Accordingly, optimum impedance matching is obtainable and the radiation efficiency can be further improved.

### BRIEF DESCRIPTION OF THE DRAWINGS

FIG. 1 is a flow chart of an antenna manufacturing method in a first preferred embodiment of the present invention.

FIG. 2 is a top view of a circuit board on which various components are mounted in a first preferred embodiment of the present invention.

FIG. 3 is a bottom view of a circuit board on which various components are mounted in a first preferred embodiment of the present invention.

FIG. 4 is a side view of a circuit board on which various components are mounted in a first preferred embodiment of the present invention.

FIG. 5 is a schematic diagram of a bit sequence in a first preferred embodiment of the present invention.

FIG. 6 is a schematic diagram of synthesis of a bit sequence in a first preferred embodiment of the present invention.

FIG. 7 is a flow chart of a conventional antenna manufacturing method.

FIG. 8 is a structural diagram of a conventional antenna.

### LIST OF REFERENCE NUMERALS

1 Circuit board
2 Shielding case
3 Antenna element
4 Battery
5 Feed pin
6 Short-circuit pin

### DETAILED DESCRIPTION OF PREFERRED EMBODIMENTS

### First Preferred Embodiment

Referring to drawings, a description of a method of manufacturing an antenna for use in mobile phones in a first preferred embodiment of the present invention will be given in the following.

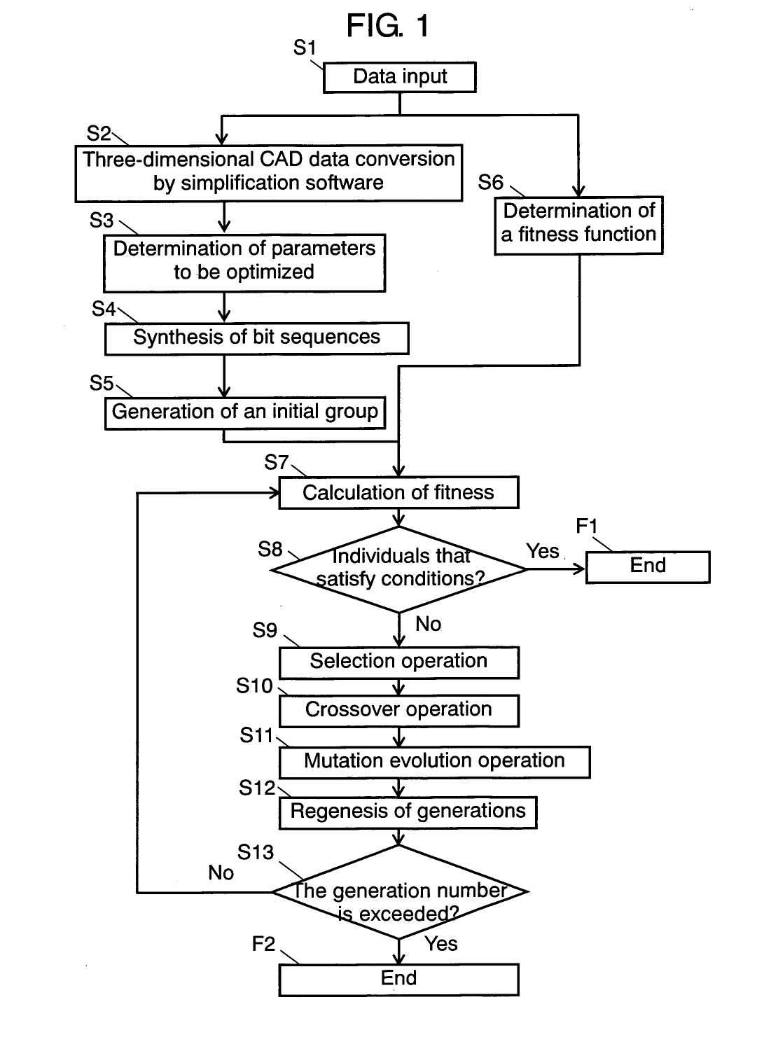

FIG. 1 is a flow chart of an antenna manufacturing method in a first preferred embodiment of the present invention. A description of the flow chart of FIG. 1 will be given below.

(1) In step S1, input is made of three-dimensional CAD data including information on the shapes, positions, and materials data of an antenna and antenna peripheral components; three-dimensional CAD data obtained by digitizing positional information and shape of a human body relative to a mobile phone, and materials data such as dielectric constants; and threshold values of the number of households to be used in genetic algorithm to be described later.

A simple description of the mechanism of genetic algorithm will be given before explaining preferred embodiment in the concrete.

Basically, genetic algorithm is a kind of multiple-point search, where each search point is called an individual. By generating new search points by means of operators such as natural selection and crossing, and mutation on a group of individuals, being a group of search points, a maximum (or a minimum) within the search space is efficiently searched.

Each individual normally has a chromosome described by a bit sequence consisting of 0 or 1, and the individual is evaluated based on an evaluated value called “fitness.” Individuals with higher fitness tend to survive in the next generation, and individuals with lower fitness tend to be culled. Descendant chromosomes are made by crossing chromosomes of two selected parent individuals. Mutation of individuals is also carried out. By generating superior individuals based on these natural selection, crossing, and mutation processes, maximum or average fitness of an individuals group is enhanced through alteration of generations, a superior individual with a high fitness, namely, a practical solution or an optimal solution to a given problem is obtained.

After the above data is inputted, subsequent process is divided into step S2 and step S6. Subsequently, the processes merge at step S7 to be described later. Here, either of these steps can be performed prior to the other or both steps can be performed simultaneously.

(2) In step S2, the three-dimensional CAD data inputted in step S1 concerning the antenna, the antenna peripheral components, and the human body is converted to a simulation model in which computation time can be shortened by using simplification software while substantially maintaining the computational accuracy. This enables processing of such a very complicated model as this in a short time in electromagnetic field simulation to be carried out when optimizing the configuration and layout of the antenna and peripheral components to be described later.

(3) In step S3, the parameters to be optimized are determined. Inside a mobile phone, there are many components such as a shielding case for protection against radio frequency noise, plating applied on the inner side of the mobile phone, battery, microphone, vibrator, etc. In this first preferred embodiment, optimum arrangement of the shielding case and battery, and optimum configuration of the circuit board and antenna are determined.

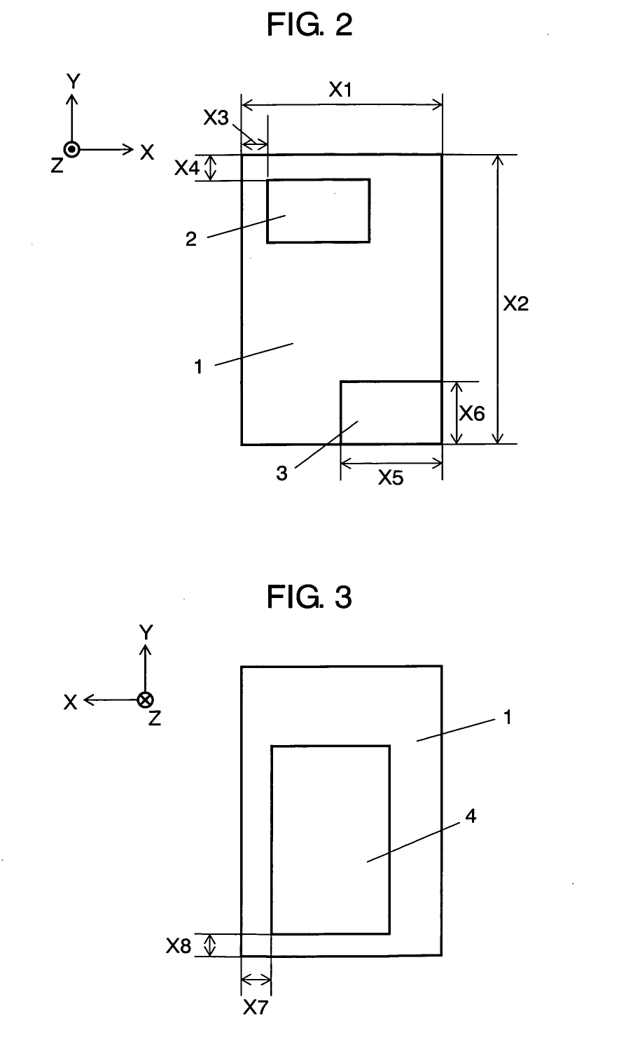

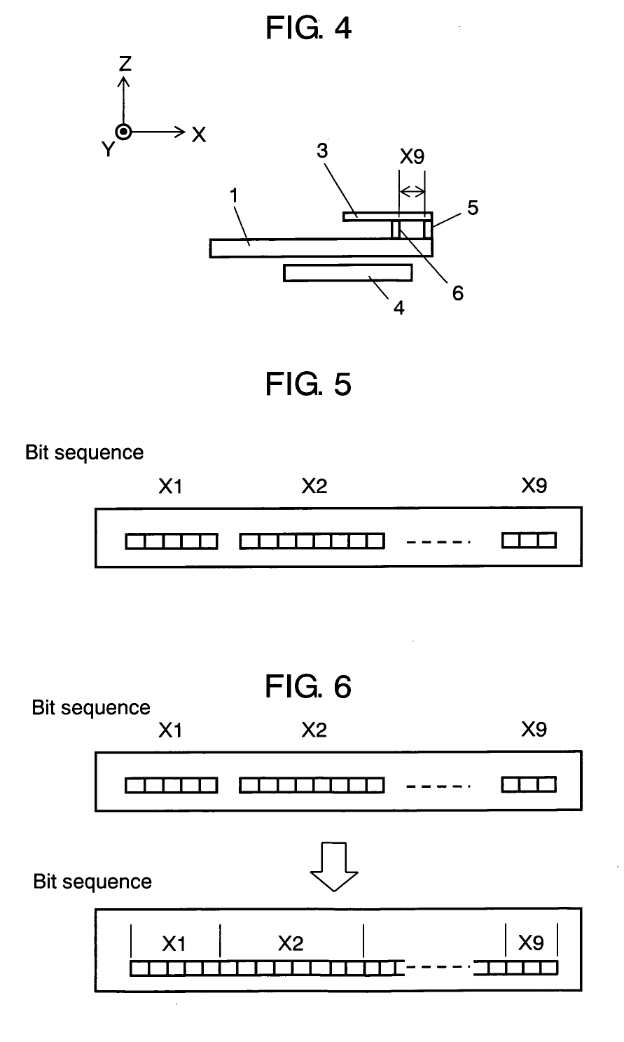

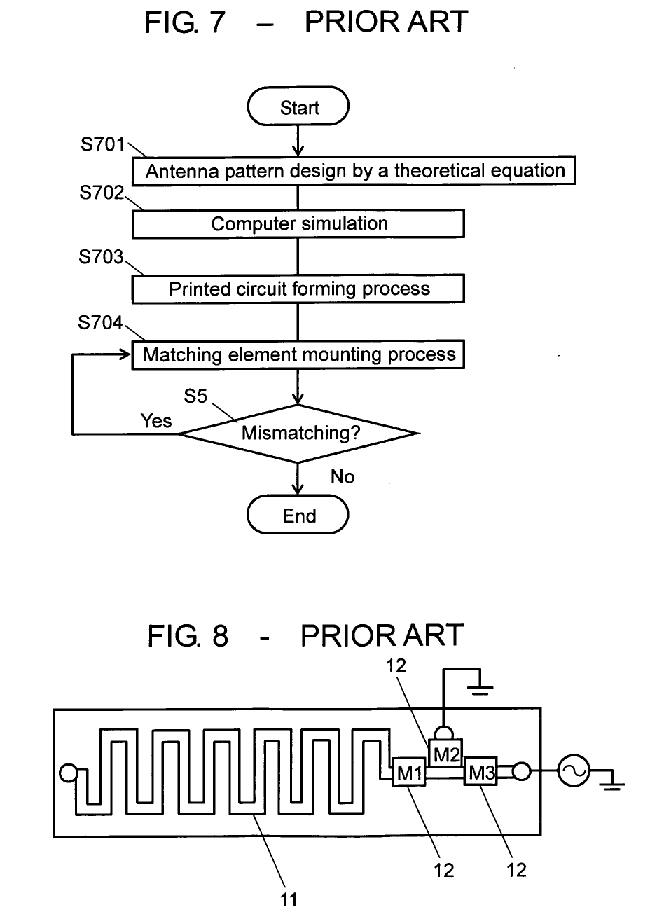

FIG. 2 is a top view of a circuit board on which various components are mounted in the first preferred embodiment of the present invention. FIG. 3 is a bottom view of the circuit board on which various components are mounted in the first preferred embodiment of the present invention. FIG. 4 is a side view of the circuit board on which various components are mounted in the first preferred embodiment of the present invention.

Here, as the parameters to be optimized, nine variables are considered, namely, length X1 in the direction of the length in direction X of circuit board 1 shown in FIG. 2, length X2 in direction Y, position X3 in the X direction and position X4 in direction Y of shielding case 2 mounted on the top face of circuit board 1, length X5 in direction X and length X6 in direction Y of antenna element 3 mounted on the top face of circuit board 1, position X7 in direction X and position X8 in direction Y of battery 4 mounted on the bottom face of circuit board 1 shown in FIG. 3, and distance X9 between feeding pin 5 and short-circuit pin 6 of antenna 3 shown in FIG. 4.

(4) In step S4, a bit sequence for each of the parameters X1 to X9 determined in step S3 is prepared.

FIG. 5 is a schematic diagram of a bit sequence in the first preferred embodiment of the present invention. In FIG. 5, supposing, for example, that the variable range of position X3 in direction X of shielding case 2 is 0 mm to 5 mm and position X3 is varied in units of 1 mm, the number of bits in each bit sequence may be determined as a binary figure that represents the digit number of the result of calculation shown in Equation 1.
(5−0)/1+1=6 (Eqn. 1)

FIG. 6 is a schematic diagram of synthesis of bit sequences in the first preferred embodiment of the present invention. In FIG. 6, a chromosome is formed by splicing bit sequences.

(5) In step S5, variables in a chromosome are randomly varied and plural individuals are generated. These plural individuals are the first generation and the number of individuals is called the “number of individuals.” Using these individuals, optimization is performed as described later. As the number of individuals is increased, diversity is maintained and the accuracy of optimization becomes higher. Instead, the amount of computation per generation increases and the number of generations until reaching the optimum solution increases. On the other hand, as the number of individuals decreases, the time for computation decreases as the amount of computations per generation and the number of generations until reaching the optimum solution decrease. However, there is a possibility of ending in a local solution as diversity is lost.

(6) In step S6, a fitness function is defined as a criterion for selecting plural individuals generated in step S5. Prior to defining the fitness function, a target function has to be made. The target function is made based on the targeted characteristic values, such as bandwidth, resonant frequency, and radiation efficiency. In the first preferred embodiment, a description will be made on weighting factor method as a simple method of defining the object function. As a technique for multi-objective optimization, many other techniques such as VEGA (Vector Evaluated Genetic Algorithm), sharing, and ranking methods are available. Here, object function g is defined as the following:
g=α·(BW_{cal}−BWₒᵥ)+β·(f_{cal}−fₒᵥ)+γ·(η_{cal}·ηₒᵥ) (Eqn. 2)

where α, β, γ:arbitrary coefficients,
BW_{cal}:bandwidth obtained by simulation,
BWₒᵥ:targeted bandwidth,
f_{cal}:resonant frequency obtained by simulation,
fₒᵥ:targeted resonant frequency,
η_{cal}:radiation efficiency obtained by simulation, ηₒᵥ:targeted radiation efficiency.

Here, as the above function has a possibility of taking a negative value depending on the value of the parameters, the fitness function is defined as below using a sigmoid function:
f(g)=1/(1+e^{g}) (Eqn. 3)

where e:natural logarithm,
g target function.

The fitness function may be defined in step S1 or in parallel with the steps S2 to S5. It may also be defined at any step after step S1 and before step S7 described below.

(7) In step S7, electromagnetic field simulation is carried out using a CAD model in which the binary number representing the number of the plural individuals generated in step S5 is replaced with a decimal number. Subsequently, resultant values of the resonant frequency, bandwidth, and radiation efficiency are substituted into Equation 3 to obtain respective fitness.

(8) In step S8, judgment is made as to whether or not there is fitness among the fitness of the plural individuals computed in step S7 that satisfies preset evaluation criteria. And, if there is fitness that satisfies the evaluation criteria, the step proceeds to end of computation F1, and the individual with fitness that satisfies the evaluation criteria is found to be the optimum solution. On the other hand, if there is no individual that satisfies the evaluation criteria, the step proceeds to step S9. As practical examples of the evaluation criteria, the following are available:

Maximum fitness in a group of individuals>threshold,

Average fitness of a group of individuals>threshold.

(9) In step S9, selection operation is performed on the individuals that did not satisfy the evaluation criteria in step S8.

(10) In step S10, crossover operation is carried out.

(11) In step S11, mutation evolution operation is carried out.

These operations are operations peculiar to genetic algorithm.

(12) In step S12, regenesis of generations is carried out based on these operations. In this case, when the operation of step S11 is finished, generation number increases by one.

(13) In step S13, if the generation number preset in step S1 is exceeded, the step proceeds to end of computation F2. If the preset generation number is not exceeded, the step returns to step S7 and optimization is tried for the second time. When shifted to end of computation F2, there is a possibility of optimum solution not being obtained. In that case, recalculation is to be made after increasing the generation number to be set to obtain optimum solution.

Furthermore, when computation is finished (shifting to F1) with conditional branching at step S8, it means that an optimum solution has been obtained. However, there can be a case in which the optimum solution that has been obtained is impossible to manufacture, the level of manufacturing difficulty is extremely high or the optimum solution is very sensitive to manufacturing dispersion.

When performing filtering with manufacturing dispersion taken into consideration, there is a method to check the distribution of the solution obtained at F1. When the distribution of the solution is narrow, there will be no large change in the characteristic even though there may be some dispersion of parameters. Conversely, when the distribution of the solution is wide, there is a possibility that the characteristic deteriorates greatly due to dispersion of parameters. It is possible to make filtering based on manufacturing dispersion by utilizing the distribution of the solution. It is better to make filtering with the degree of difficulty of manufacturing. At this time, though filtering was made in the last step, it is possible to incorporate it in the optimization cycle (steps S7 to S13) of the genetic algorithm.

According to such an antenna manufacturing method as that of the present invention, because simulation is carried out using not only the information of the antenna alone but also the information of peripheral components as the variables, it is possible to make overall optimization including impedance matching of a communications device including the antenna, and improve antenna radiation efficiency without requiring a matching element.

### INDUSTRIAL APPLICABILITY

The antenna manufacturing method of the present invention enables optimization including impedance matching without requiring a matching element and provides an antenna having improved radiation efficiency.

1. An antenna manufacturing method comprising the steps of:
inputting as variables:
shape of a case;
position of an antenna in the case;
shape of the antenna;
position of antenna peripheral components in the case; and
the shape of the antenna peripheral components; and computing optimum value of the variables by using a simulation program.

2. A method of manufacturing a communication device comprising the steps of:
inputting as variables:
shape of a case;
position of an antenna in the case;
shape of the antenna;
position of antenna peripheral components in the case; and
shape of the antenna peripheral components; and
computing optimum value of the variables by using a simulation program.

3. An antenna manufacturing method comprising the steps of:
inputting as variables;
shape of a case;
position of an antenna in the case;
shape of the antenna;
position of antenna peripheral components in the case; and
shape of the antenna peripheral components;
inputting as constants information on the shape and placement of a human body; and
computing optimum value of the variables by using a simulation program.

4. A method of manufacturing a communication device comprising the steps of:
inputting as variables:
shape of a case;
position of an antenna in the case;
shape of the antenna;
position of antenna peripheral components in the case; and
shape of the antenna peripheral components;
inputting as constants information on the shape and placement of a human body; and
computing optimum value of the variables by using a simulation program.
